(19) United States
(12) Patent Application Publication
(10) Pub. No.: US 2006/0058192 A1
(43) Pub. Date: Mar. 16, 2006

(54) Herbicidal composition

(76) Inventor: Georg Rudiger Kotzian, Basel (CH)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/535,686

(22) PCT Filed: Nov. 20, 2003
(86) PCT No.: PCT/EP03/13024

§ 371 Date: May 19, 2005

(30) Foreign Application Priority Data
Nov. 21, 2002 (CH) 1957102
Jun. 6, 2003 (CH) 1001/03

(51) Int. Cl. A01N 43/40

(52) U.S. Cl. 504/130

(57) ABSTRACT

A herbicidal synergistic composition which, in addition to comprising customary inert formulation adjuvants, comprises as active ingredient a mixture of a) pyribenzoxim and b) a synergistically effective amount of at least one compound selected from the compounds of the group benzobicyclon, benzofenap, pyraflufen-ethyl, beflubutamid, cafenstrole, dimethametryn, clomeprop, trifloxysulfuron, N-[(4,6-dimethoxypyrimidin-2-yl)aminocarbonyl]-2-(2-fluoro-1-methoxy-acetoxy-n-propyl)pyridine-3-sulfonamide, S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester, isoxachlortole, chlomethoxyfen, fomesafen, halosafen, lactofen, oxyfluorfen, fluazolate, benzfendizone, cinidon-ethyl, flumiclorac-pentyl, flumioxazin, azafenidin, pentoxazone, profluazol, flufenpyr-ethyl, pyraclonil, pyriftalid, bispyribac-sodium, pyrithiobac-sodium, pyriminobac-sodium, clodinafop, fenoxaprop, cyhalofop, quizalofop, clethodim and sethoxydim. The compositions according to the invention may also comprise a safener.

The present invention relates to a novel herbicidal synergistic composition comprising a herbicidal active ingredient combination that is suitable for the selective control of weeds in crops of useful plants, for example in crops of rice.

The invention relates also to a method of controlling weeds in crops of useful plants and to the use of the novel composition for that purpose.

The compounds benzobicyclon (70), benzofenap (71), pyraflufen-ethyl (662), beflubutamid (57), dimethametryn (253), clomeprop (160), S-metolachlor (530), alachlor (16), fomesafen (391), halosafen (superseded record no. 1156), lactofen (473), oxyfluorfen (589), fluazolate (355), cinidon-ethyl (152), flumiclorac-pentyl (367), flumioxazin (368), azafenidin (43), pentoxazone (602), bispyribac-sodium (82), pyrithiobac-sodium (678), pyriminobac-methyl (676), clodinafop-propargyl (156), fenoxaprop (superseded record no. 1104), cyhalofop-butyl (191), quizalofop (686), clethodim (155), sethoxydim (694), benoxacor (65), fenclorim (325), dichlormid (225), mefenpyr-diethyl (492), chlomethoxyfen (superseded record no. 903) and pyribenzoxim (668), and agronomically acceptable salts thereof, exhibit herbicidal action, as is described, for example, in The Pesticide Manual, 12th Edition (BCPC), 2000 under the entry numbers indicated in brackets.

Tritosulfuron, registered as no. 142469-14-5 in CAS (Chemical Abstracts) is known from EP-A-559 814 and WO 01/24633. The herbicidal action of that compound is also described therein.

Pyraclonil (1-(3-chloro-4,5,6,7-tetrahydropyrazolo[1,5-a]pyridin-2-yl)-5-(methyl-2-propynyl-amino)-1H-pyrazole-4-carbonitrile, registered as RN 158353-15-2 in CAS (Chemical Abstracts)), is known from WO 94/08999. The herbicidal action of that compound is also described therein.

Isoxachlortole ([4-chloro-2-(methylsulfonyl)phenyl](5-cyclopropyl-4-isoxazolyl)methanone, registered as RN 141112-06-3 in CAS (Chemical Abstracts)), and its herbicidal action are known from EP 470 856.

Profluazol (1-chloro-N-[2-chloro-4-fluoro-5-[(6S,7aR)-6-fluorotetrahydro-1,3-dioxo-1H-pyrrolo[1,2-c]imidazol-2(3H)-yl]phenyl]methanesulfonamide, registered as RN 190314-43-3 in CAS (Chemical Abstracts)), is known from WO 97/15576. The herbicidal action of that compound is also described therein.

Benzfendizone (methyl 2-[2-[[4-[3,6-dihydro-3-methyl-2,6-dioxo-4-(trifluoromethyl)-1 (2H)-pyrimidinyl]phenoxy]methyl]-5-ethylphenoxy]propanoate, RN 158755-954 in CAS (Chemical Abstracts)), and its herbicidal action are known from WO 97/08953.

Trifloxysulfuron and its herbicidal action are known, for example, from WO 00/52006.

The compound N-[(4,6-dimethoxypyrimidin-2-yl)aminocarbonyl]-2-(2-fluoro-1-methoxy-acetoxy-n-propyl)pyridine-3-sulfonamide and its herbicidal action are known from WO 02/30921.

The compound 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester and its herbicidal action are known from U.S. Pat. No. 6,410,480.

The herbicidal action of metamifop is known, for example, from WO 00/05956.

Pyriftalid, registered as RN 135186-78-6 in CAS (Chemical Abstracts), is known from WO 91/05781. The herbicidal action of that compound is also described therein.

The herbicidal action of metamifop (RN 256412-89-2) is known, for example, from WO 00/05956.

Flufenpyr-ethyl ([2-chloro-4-fluoro-5-[5-methyl-6-oxo-4-(trifluoromethyl)-1 (6H-pyridazinyl]-phenoxy]acetic acid, RN 188490-07-5, and its ethyl ester RN 188489-07-8 in CAS (Chemical Abstracts)). The herbicidal action of that compound is also described therein.

Surprisingly, it has now been found that a combination of variable amounts of pyribenzoxim with at least one active ingredient from the above listing exhibits a synergistic action that is capable of controlling, both pre-emergence and post-emergence, the majority of weeds occurring especially in crops of useful plants, without appreciably damaging the useful plants.

There is therefore proposed in accordance with the present invention a novel synergistic composition for the selective control of weeds which, in addition to comprising customary inert formulation adjuvants, comprises as active ingredient a mixture of
a) pyribenzoxim and
b) a synergistically effective amount of at least one compound selected from the compounds of the group benzobicyclon, benzofenap, pyraflufen-ethyl, beflubutamid, dimethametryn, clomeprop, trifloxysulfuron, N-[(4,6-dimethoxypyrimidin-2-yl)aminocarbonyl]-2-(2-fluoro-1-methoxy-acetoxy-n-propyl)pyridine-3-sulfonamide, S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester, isoxachlortole, chlomethoxyfen, fomesafen, halosafen, lactofen, oxyfluorfen, fluazolate, benzfendizone, cinidon-ethyl, flumiclorac-pentyl, flumioxazin, azafenidin, pentoxazone, profluazol, flufenpyr-ethyl, pyraclonil, pyriftalid, bispyribac-sodium, pyrithiobac-sodium and pyriminobac-sodium, and agronomically acceptable salts thereof.

It is extremely surprising that combinations of those active ingredients exceed the additive effect on the weeds to be controlled that is to be expected in principle and thus broaden the range of action of both active ingredients especially in two respects: firstly, the rates of application of the individual compounds are reduced while a good level of action is maintained and, secondly, the composition according to the invention achieves a high level of weed control also in those cases where the individual substances, in the low rates of application range, have become useless from the agronomic standpoint. The result is a considerable broadening of the spectrum of weeds and an additional increase in selectivity in respect of the crops of useful plants, as is necessary and desirable in the event of an unintentional overdose of active ingredient. The composition according to the invention, while retaining excellent control of weeds in crops of useful plants, also allows greater flexibility in succeeding crops.

The composition according to the invention can be used against a large number of agronomically important weeds, such as Stellaria, Nasturtium, Agrostis, Digitaria, Avena, Setaria, Sinapis, Lolium, Solanum, Bromus, Apera, Alopecurus, Matricaria, Abutilon, Sida, Xanthium, Amaranthus, Chenopodium, Ipomoea, Chrysanthemum, Galium, Viola and Veronica. The composition according to the invention is suitable for all methods of application conventionally used in agriculture, e.g. pre-emergence application, post-emergence application and seed dressing. The composition according to the invention is suitable for controlling weeds in rice. “Crops of useful plants” are to be understood to mean also those which have been made tolerant to herbicides or classes of herbicides as a result of conventional methods of breeding or genetic engineering methods.

The composition according to the invention comprises the mentioned active ingredients in any mixing ratio, but usually has an excess of one component over the other. Preferred mixing ratios of the active ingredients are from 100:1 to 1:100 and 50:1 to 1:50.

Compositions that have been found to be especially effective are the combinations pyribenzoxim and mesotrione, pyribenzoxim and benzobicyclon, pyribenzoxim and benzofenap, pyribenzoxim and pyraflufen-ethyl, pyribenzoxim and beflubutamid, pyribenzoxim and cafenstrole, pyribenzoxim and dimethametryn, pyribenzoxim and clomeprop, pyribenzoxim and prometryn, pyribenzoxim and simetryn, pyribenzoxim and trifloxysulfuron, pyribenzoxim and S-metolachlor, pyribenzoxim and alachlor, pyribenzoxim and metamifop, pyribenzoxim and 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester, pyribenzoxim and isoxachlortole, pyribenzoxim and chlomethoxyfen, pyribenzoxim and fomesafen, pyribenzoxim and halosafen, pyribenzoxim and lactofen, pyribenzoxim and oxyfluorfen, pyribenzoxim and fluazolate, pyribenzoxim and benzfendizone, pyribenzoxim and cinidon-ethyl, pyribenzoxim and flumiclorac-pentyl, pyribenzoxim and flumioxazin, pyribenzoxim and azafenidin, pyribenzoxim and pentoxazone, pyribenzoxim and profluazol, pyribenzoxim and flufenpyr-ethyl, pyribenzoxim and pyraclonil, pyribenzoxim and pyriftalid, pyribenzoxim and bispyribac-sodium, pyribenzoxim and pyrithiobac-sodium, pyribenzoxim and pyriminobac-sodium, pyribenzoxim and mesotrione and cinosulfuron, pyribenzoxim and benzobicyclon and cinosulfuron, pyribenzoxim and pyraflufen-ethyl and cinosulfuron, pyribenzoxim and beflubutamid and cinosulfuron, pyribenzoxim and cafenstrole and cinosulfuron, pyribenzoxim and dimethametryn and cinosulfuron, pyribenzoxim and clomeprop and cinosulfuron, pyribenzoxim and prometryn and cinosulfuron, pyribenzoxim and simetryn and cinosulfuron, pyribenzoxim and trifloxysulfuron and cinosulfuron, pyribenzoxim and mesotrione and triasulfuron, pyribenzoxim and benzobicyclon and triasulfuron, pyribenzoxim and benzofenap and triasulfuron, pyribenzoxim and pyraflufen-ethyl and triasulfuron, pyribenzoxim and beflubutamid and triasulfuron, pyribenzoxim and cafenstrole and triasulfuron, pyribenzoxim and dimethametryn and triasulfuron, pyribenzoxim and clomeprop and triasulfuron, pyribenzoxim and prometryn and triasulfuron, pyribenzoxim and simetryn and triasulfuron, pyribenzoxim and trifloxysulfuron and triasulfuron, pyribenzoxim and mesotrione and prosulfuron, pyribenzoxim and benzobicyclon and prosulfuron, pyribenzoxim and benzofenap and prosulfuron, pyribenzoxim and pyraflufen-ethyl and prosulfuron, pyribenzoxim and beflubutamid and prosulfuron, pyribenzoxim and cafenstrole and prosulfuron, pyribenzoxim and dimethametryn and prosulfuron, pyribenzoxim and clomeprop and prosulfuron, pyribenzoxim and prometryn and prosulfuron, pyribenzoxim and simetryn and prosulfuron, pyribenzoxim and trifloxysulfuron and prosulfuron, pyribenzoxim and mesotrione and trifloxysulfuron, pyribenzoxim and sulcotrione and trifloxysulfuron, pyribenzoxim and isoxaflutole and trifloxysulfuron, pyribenzoxim and benzobicyclon and trifloxysulfuron, pyribenzoxim and pyrazoxyfen and trifloxysulfuron, pyribenzoxim and pyrazolynate and trifloxysulfuron, pyribenzoxim and benzofenap and trifloxysulfuron, pyribenzoxim and bentazone and trifloxysulfuron, pyribenzoxim and sulfentrazone and trifloxysulfuron, pyribenzoxim and pyraflufen-ethyl and trifloxysulfuron, pyribenzoxim and beflubutamid and trifloxysulfuron, pyribenzoxim and cafenstrole and trifloxysulfuron, pyribenzoxim and dimethametryn and trifloxysulfuron, pyribenzoxim and clomeprop and trifloxysulfuron, pyribenzoxim and prometryn and trifloxysulfuron, pyribenzoxim and simetryn and trifloxysulfuron, pyribenzoxim and mesotrione and metsulfuron, pyribenzoxim and sulcotrione and metsulfuron, pyribenzoxim and isoxaflutole and metsulfuron, pyribenzoxim and benzobicyclon and metsulfuron, pyribenzoxim and pyrazoxyfen and metsulfuron, pyribenzoxim and pyrazolynate and metsulfuron, pyribenzoxim and benzofenap and metsulfuron, pyribenzoxim and bentazone and metsulfuron, pyribenzoxim and pyraflufen-ethyl and metsulfuron, pyribenzoxim and beflubutamid and metsulfuron, pyribenzoxim and cafenstrole and metsulfuron, pyribenzoxim and dimethametryn and metsulfuron, pyribenzoxim and clomeprop and metsulfuron, pyribenzoxim and prometryn and metsulfuron, pyribenzoxim and simetryn and metsulfuron, pyribenzoxim and trifloxysulfuron and metsulfuron, pyribenzoxim and mesotrione and bensulfuron, pyribenzoxim and sulcotrione and bensulfuron, pyribenzoxim and isoxaflutole and bensulfuron, pyribenzoxim and benzobicyclon and bensulfuron, pyribenzoxim and pyrazoxyfen and bensulfuron, pyribenzoxim and pyrazolynate and bensulfuron, pyribenzoxim and benzofenap and bensulfuron, pyribenzoxim and pyraflufen-ethyl and bensulfuron, pyribenzoxim and beflubutamid and bensulfuron, pyribenzoxim and cafenstrole and bensulfuron, pyribenzoxim and dimethametryn and bensulfuron, pyribenzoxim and clomeprop and bensulfuron, pyribenzoxim and prometryn and bensulfuron, pyribenzoxim and simetryn and bensulfuron, pyribenzoxim and trifloxysulfuron and bensulfuron, pyribenzoxim and mesotrione and pyrazosulfuron, pyribenzoxim and sulcotrione and pyrazosulfuron, pyribenzoxim and isoxaflutole and pyrazosulfuron, pyribenzoxim and benzobicyclon and pyrazosulfuron, pyribenzoxim and pyrazoxyfen and pyrazosulfuron, pyribenzoxim and pyrazolynate and pyrazosulfuron, pyribenzoxim and benzofenap and pyrazosulfuron, pyribenzoxim and pyraflufen-ethyl and pyrazosulfuron, pyribenzoxim and beflubutamid and pyrazosulfuron, pyribenzoxim and cafenstrole and pyrazosulfuron, pyribenzoxim and dimethametryn and pyrazosulfuron, pyribenzoxim and clomeprop and pyrazosulfuron, pyribenzoxim and prometryn and pyrazosulfuron, pyribenzoxim and simetryn and pyrazosulfuron, pyribenzoxim and trifloxysulfuron and pyrazosulfuron, pyribenzoxim and mesotrione and azimsulfuron, pyribenzoxim and sulcotrione and azimsulfuron, pyribenzoxim and isoxaflutole and azimsulfuron, pyribenzoxim and benzobicyclon and azimsulfuron, pyribenzoxim and pyrazoxyfen and azimsulfuron, pyribenzoxim and pyrazolynate and azimsulfuron, pyribenzoxim and benzofenap and azimsulfuron, pyribenzoxim and bentazone and azimsulfuron, pyribenzoxim and sulfentrazone and azimsulfuron, pyribenzoxim and pyraflufen-ethyl and azimsulfuron, pyribenzoxim and beflubutamid and azimsulfuron, pyribenzoxim and cafenstrole and azimsulfuron, pyribenzoxim and dimethametryn and azimsulfuron, pyribenzoxim and clomeprop and azimsulfuron, pyribenzoxim and prometryn and azimsulfuron, pyribenzoxim and simetryn and azimsulfuron, pyribenzoxim and trifloxysulfuron and azimsulfuron, pyribenzoxim and mesotrione and imazosulfuron, pyribenzoxim and sulcotrione and imazosulfuron, pyribenzoxim and isoxaflutole and imazosulfuron, pyribenzoxim and benzobicyclon and imazosulfuron, pyribenzoxim and pyrazoxyfen and imazosulfuron, pyribenzoxim and pyrazolynate and imazosulfuron, pyribenzoxim and benzofenap and imazosulfuron, pyribenzoxim and pyraflufen-ethyl and imazosulfuron, pyribenzoxim and beflubutamid and imazosulfuron, pyribenzoxim and cafenstrole and imazosulfuron, pyribenzoxim and dimethametryn and imazosulfuron, pyribenzoxim and clomeprop and imazosulfuron, pyribenzoxim and prometryn and imazosulfuron, pyribenzoxim and simetryn and imazosulfuron, pyribenzoxim and trifloxysulfuron and imazosulfuron, pyribenzoxim and sulcotrione and ethoxysulfuron, pyribenzoxim and isoxaflutole and ethoxysulfuron, pyribenzoxim and benzobicyclon and ethoxysulfuron, pyribenzoxim and pyrazoxyfen and ethoxysulfuron, pyribenzoxim and pyrazolynate and ethoxysulfuron, pyribenzoxim and benzofenap and ethoxysulfuron, pyribenzoxim and pyraflufen-ethyl and ethoxysulfuron, pyribenzoxim and beflubutamid and ethoxysulfuron, pyribenzoxim and cafenstrole and ethoxysulfuron, pyribenzoxim and dimethametryn and ethoxysulfuron, pyribenzoxim and clomeprop and ethoxysulfuron, pyribenzoxim and prometryn and ethoxysulfuron, pyribenzoxim and simetryn and ethoxysulfuron, pyribenzoxim and trifloxysulfuron and ethoxysulfuron, pyribenzoxim and mesotrione and sulfosulfuron, pyribenzoxim and sulcotrione and sulfosulfuron, pyribenzoxim and isoxaflutole and sulfosulfuron, pyribenzoxim and benzobicyclon and sulfosulfuron, pyribenzoxim and pyrazoxyfen and sulfosulfuron, pyribenzoxim and pyrazolynate and sulfosulfuron, pyribenzoxim and benzofenap and sulfosulfuron, pyribenzoxim and bentazone and sulfosulfuron, pyribenzoxim and pyraflufen-ethyl and sulfosulfuron, pyribenzoxim and beflubutamid and sulfosulfuron, pyribenzoxim and cafenstrole and sulfosulfuron, pyribenzoxim and dimethametryn and sulfosulfuron, pyribenzoxim and clomeprop and sulfosulfuron, pyribenzoxim and prometryn and sulfosulfuron, pyribenzoxim and simetryn and sulfosulfuron, pyribenzoxim and trifloxysulfuron and sulfosulfuron, pyribenzoxim and benzobicyclon and iodosulfuron, pyribenzoxim and benzofenap and iodosulfuron, pyribenzoxim and pyraflufen-ethyl and iodosulfuron, pyribenzoxim and beflubutamid and iodosulfuron, pyribenzoxim and dimethametryn and iodosulfuron, pyribenzoxim and clomeprop and iodosulfuron, pyribenzoxim and trifloxysulfuron and iodosulfuron, pyribenzoxim and isoxaflutole and mesosulfuron, pyribenzoxim and benzobicyclon and mesosulfuron, pyribenzoxim and pyrazoxyfen and mesosulfuron, pyribenzoxim and benzofenap and mesosulfuron, pyribenzoxim and sulfentrazone and mesosulfuron, pyribenzoxim and pyraflufen-ethyl and mesosulfuron, pyribenzoxim and beflubutamid and mesosulfuron, pyribenzoxim and dimethametryn and mesosulfuron, pyribenzoxim and clomeprop and mesosulfuron, pyribenzoxim and trifloxysulfuron and mesosulfuron, pyribenzoxim and mesotrione and tritosulfuron, pyribenzoxim and benzobicyclon and tritosulfuron, pyribenzoxim and benzofenap and tritosulfuron, pyribenzoxim and pyraflufen-ethyl and tritosulfuron, pyribenzoxim and beflubutamid and tritosulfuron, pyribenzoxim and cafenstrole and tritosulfuron, pyribenzoxim and dimethametryn and tritosulfuron, pyribenzoxim and clomeprop and tritosulfuron, pyribenzoxim and prometryn and tritosulfuron, pyribenzoxim and simetryn and tritosulfuron, pyribenzoxim and trifloxysulfuron and tritosulfuron, pyribenzoxim and mesotrione and N-[(4,6-dimethoxypyrimidin-2-yl)aminocarbonyl]-2-(2-fluoro-1-methoxy-acetoxy-n-propyl)pyridine-3-sulfonamide, pyribenzoxim and sulcotrione and N-[(4,6-dimethoxypyrimidin-2-yl)aminocarbonyl]-2-(2-fluoro-1-methoxy-acetoxy-n-propyl)pyridine-3-sulfonamide, pyribenzoxim and isoxaflutole and N-[(4,6-dimethoxypyrimidin-2-yl)aminocarbonyl]-2-(2-fluoro-1-methoxy-acetoxy-n-propyl)pyridine-3-sulfonamide, pyribenzoxim and benzobicyclon and N-[(4,6-dimethoxypyrimidin-2-yl)aminocarbonyl]]-2-(2-fluoro-1-methoxy-acetoxy-n-propyl)pyridine-3-sulfonamide, pyribenzoxim and pyrazoxyfen and N-[(4,6-dimethoxypyrimidin-2-yl)aminocarbonyl]-2-(2-fluoro-1-methoxy-acetoxy-n-propyl)pyridine-3-sulfonamide, pyribenzoxim and pyrazolynate and N-[(4,6-dimethoxypyrimidin-2-yl)aminocarbonyl]-2-(2-fluoro-1-methoxy-acetoxy-n-propyl)pyridine-3-sulfonamide, pyribenzoxim and benzofenap and N-[(4,6-dimethoxypyrimidin-2-yl)aminocarbonyl]-2-(2-fluoro-1-methoxy-acetoxy-n-propyl)pyridine-3-sulfonamide, pyribenzoxim and bentazone and N-[(4,6-dimethoxy-pyrimidin-2-yl)aminocarbonyl]-2-(2-fluoro-1-methoxy-acetoxy-n-propyl)pyridine-3-sulfonamide, pyribenzoxim and sulfentrazone and N-[(4,6-dimethoxypyrimidin-2-yl)aminocarbonyl]-2-(2-fluoro-1-methoxy-acetoxy-n-propyl)pyridine-3-sulfonamide, pyribenzoxim and pyraflufen-ethyl and N-[(4,6-dimethoxypyrimidin-2-yl)aminocarbonyl]-2-(2-fluoro-1-methoxy-acetoxy-n-propyl)pyridine-3-sulfonamide, pyribenzoxim and beflubutamid and N-[(4,6-dimethoxypyrimidin-2-yl)aminocarbonyl]-2-(2-fluoro-1-methoxy-acetoxy-n-propyl)pyridine-3-sulfonamide, pyribenzoxim and cafenstrole and N-[(4,6-dimethoxypyrimidin-2-yl)aminocarbonyl]-2-(2-fluoro-1-methoxy-acetoxy-n-propyl)pyridine-3-sulfonamide, pyribenzoxim and dimethametryn and N-[(4,6-dimethoxypyrimidin-2-yl)aminocarbonyl]-2-(2-fluoro-1-methoxy-acetoxy-n-propyl)pyridine-3-sulfonamide, pyribenzoxim and clomeprop and N-[(4,6-dimethoxypyrimidin-2-yl)aminocarbonyl]-2-(2-fluoro-1-methoxy-acetoxy-n-propyl)pyridine-3-sulfonamide, pyribenzoxim and prometryn and N-[(4,6-dimethoxypyrimidin-2-yl)aminocarbonyl]-2-(2-fluoro-1-methoxy-acetoxy-n-propyl)pyridine-3-sulfonamide, pyribenzoxim and simetryn and N-[(4,6-dimethoxypyrimidin-2-yl)aminocarbonyl]-2-(2-fluoro-1-methoxy-acetoxy-n-propyl)pyridine-3-sulfonamide, pyribenzoxim and trifloxysulfuron and N-[(4,6-dimethoxypyrimidin-2-yl)aminocarbonyl]-2-(2-fluoro-1-methoxy-acetoxy-n-propyl)pyridine-3-sulfonamide, pyribenzoxim and simetryn and N-[(4,6-dimethoxypyrimidin-2-yl)aminocarbonyl]-2-(2-fluoro-1-methoxy-acetoxy-n-propyl)pyridine-3-sulfonamide.

The rate of application may vary within wide limits and depends on the nature of the soil, the method of application (pre- or post-emergence; seed dressing; application to the seed furrow; no tillage application etc.), the crop plant, the weed to be controlled, the prevailing climatic conditions, and other factors governed by the method of application, the time of application and the target crop. The active ingredient mixture according to the invention can generally be applied at a rate of from 0.001 to 1.5 kg of active ingredient mixture per hectare.

The mixtures according to the invention may be used in unmodified form, that is to say as obtained in synthesis. Preferably, however, they are formulated in customary manner, together with the adjuvants conventionally used in formulation technology, such as solvents, solid carriers or surfactants, for example into emulsifiable concentrates, directly sprayable or dilutable solutions, wettable powders, soluble powders, dusts, granules or microcapsules, as is described in WO 97/34483, pages 9 to 13. As with the nature of the compositions, the methods of application, such as spraying, atomising, dusting, wetting, scattering or pouring, are chosen in accordance with the intended objectives and the prevailing circumstances. The formulations, i.e. the compositions, preparations or products comprising the mixtures according to the invention, and also, where appropriate, one or more solid or liquid formulation adjuvants, are prepared in a manner known per se, e.g. by intimately mixing and/or grinding the active ingredients with the formulation adjuvants, e.g. solvents or solid carriers. In addition, surface-active compounds (surfactants) may also be used in the preparation of the formulations.

Examples of solvents and solid carriers are given, for example, in WO 97/34485, page 6. Depending on the nature of the pyribenzoxim to be formulated, suitable surface-active compounds are non-ionic, cationic and/or anionic surfactants and surfactant mixtures having good emulsifying, dispersing and wetting properties. Examples of suitable anionic, non-ionic and cationic surfactants are listed, for example, in WO 97/34485, pages 7 and 8. Also suitable for the preparation of the herbicidal compositions according to the invention are the surfactants conventionally used in formulation technology, which are described, inter alia, in “McCutcheon's Detergents and Emulsifiers Annual” MC Publishing Corp., Ridgewood N.J., 1981, Stache, H., “Tensid-Taschenbuch”, Carl HanserVerlag, MunichNienna, 1981 and M. and J. Ash, “Encyclopedia of Surfactants”, Vol I-III, Chemical Publishing Co., New York, 1980-81.

The herbicidal formulations usually contain from 0.1 to 99% by weight, especially from 0.1 to 95% by weight, of active ingredient mixture, from 1 to 99.9% by weight of a solid or liquid formulation adjuvant, and from 0 to 25% by weight, especially from 0.1 to 25% by weight, of a surfactant.

Whereas the preferred commercial products are usually concentrates, the end user will normally employ dilute formulations. The compositions may also comprise further ingredients, such as stabilisers, e.g. vegetable oils or epoxidised vegetable oils (epoxidised coconut oil, rapeseed oil or soybean oil), antifoams, e.g. silicone oil, preservatives, viscosity regulators, binders, tackifiers, and also fertilisers or other active ingredients. Preferred formulations have especially the following compositions:
(%=percent by weight)

Emulsifiable Concentrates:

| | |
|---|---|
| active ingredient mixture: | from 1 to 90%, preferably from 5 to 20% |
| surface-active agent: | from 1 to 30%, preferably from 10 to 20% |
| liquid carrier: | from 5 to 94%, preferably from 70 to 85% |

Dusts:

| | |
|---|---|
| active ingredient mixture: | from 0.1 to 10%, preferably from 0.1 to 5% |
| solid carrier: | from 99.9 to 90%, preferably from 99.9 to 99% |

Suspension Concentrates:

| | |
|---|---|
| active ingredient mixture: | from 5 to 75%, preferably from 10 to 50% |
| water: | from 94 to 24%, preferably from 88 to 30% |
| surface-active agent: | from 1 to 40%, preferably from 2 to 30% |

Wettable Powders:

| | |
|---|---|
| active ingredient mixture: | from 0.5 to 90%, preferably from 1 to 80% |
| surface-active agent: | from 0.5 to 20%, preferably from 1 to 15% |
| solid carrier: | from 5 to 95%, preferably from 15 to 90% |

Granules:

| | |
|---|---|
| active ingredient mixture: | from 0.1 to 30%, preferably from 0.1 to 15% |
| solid carrier: | from 99.5 to 70%, preferably from 97 to 85% |

The Examples that follow illustrate the invention further. They do not limit the invention.

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| aromatic C₉-C₁₂hydrocarbon mixture | 85% | 78% | 55% | 16% |

Emulsions of any desired concentration can be prepared from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol (mol. wt. 400) | 20% | 10% | — | — |
| N-methyl-2-pyrrolidone | — | — | 30% | 10% |
| aromatic C₉-C₁₂hydrocarbon mixture | 75% | 60% | — | — |

The solutions are suitable for application in the form of micro-drops.

| F3. Wettable Dowders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalenesulfonate | — | 6% | 5% | 6% |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier material | 99.0% | 93% | 83% |
| (diameter 0.1 - 1 mm) | | | |
| for example CaCO₃ or SiO₂ | | | |

The active ingredient is dissolved in methylene chloride, the solution is sprayed onto the carrier, and the solvent is subsequently evaporated off in vacuo.

| F5. Coated granules | a) | b) | c) |
|---|---|---|---|
| active ingredient mixture | 0.1% | 5% | 15% |
| polyethylene glycol (mol. wt. 200) | 1.0% | 2% | 3% |
| highly dispersed silicic acid | 0.9% | 1% | 2% |
| inorganic carrier material | 98.0% | 92% | 80% |
| (diameter 0.1 - 1 mm) | | | |
| for example CaCO₃ or SiO₂ | | | |

The finely ground active ingredient is uniformly applied, in a mixer, to the carrier material moistened with polyethylene glycol, yielding non-dusty coated granules.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed with the adjuvants, and the mixture is ground, moistened with water, extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethyleneglycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical to formulate the active ingredients of the mixtures according to the invention separately and then, shortly before application, to bring them together in the applicator in the desired mixing ratio in the form of a “tank mixture” in water.

### BIOLOGICAL EXAMPLES

### Example B1

### Pre-Emergence Test

The test plants are sown in pots under greenhouse conditions. A standard soil is used as cultivation substrate. At a pre-emergence stage, the herbicides, both on their own and in admixture, are applied to the surface of the soil. The rates of application depend on the optimum concentrations ascertained under field conditions or greenhouse conditions. The tests are evaluated after from 2 to 4 weeks (100% action=plant is completely dead; 0% action=no phytotoxic action). The mixtures used in this test show good results.

### Example B2

### Post-Emergence Test

The test plants are cultivated in pots under greenhouse conditions until a post-application stage. A standard soil is used as cultivation substrate. At a post-emergence stage, the herbicides, both on their own and in admixture, are applied to the test plants. The rates of application depend on the optimum concentrations ascertained under field conditions or greenhouse conditions. The tests are evaluated after from 2 to 4 weeks (100% action=plant is completely dead; 0% action=no phytotoxic action). The mixtures used in this test show good results.

It has been shown, surprisingly, that specific safeners are suitable for mixing with the synergistic composition according to the invention. The present invention accordingly relates also to a selectively herbicidal composition for selectively controlling weeds in crops of useful plants, especially in crops of rice, that comprises the compound pyribenzoxim, optionally one or more compounds selected from the compounds S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester, isoxachlortole, chlomethoxyfen, fomesafen, halosafen, lactofen, oxyfluorfen, fluazolate, benzfendizone, cinidon-ethyl, flumiclorac-pentyl, flumioxazin, azafenidin, pentoxazone, profluazol, flufenpyr-ethyl, pyraclonil, pyriftalid, bispyribac-sodium, pyrithiobac-sodium, pyriminobac-sodium, clodinafop, fenoxaprop, cyhalofop, quizalofop, clethodim and sethoxydim, and a safener (counter agent, antidote) that protects the useful plants, but not the weeds, against the phytotoxic action of the herbicide, as well as to the use of such a composition in the control of weeds in crops of useful plants.

In accordance with the invention there is accordingly also proposed a selectively herbicidal composition which, in addition to comprising customary inert formulation adjuvants such as carriers, solvents and wetting agents, comprises as active ingredient a mixture of a) an amount, effective for herbicide synergism, of pyribenzoxim, optionally one or more compounds selected from the compounds S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d]-[1,4,5]oxadiazepin-7-yl ester, isoxachlortole, chlomethoxyfen, fomesafen, halosafen, lactofen, oxyfluorfen, fluazolate, benzfendizone, cinidon-ethyl, flumiclorac-pentyl, flumioxazin, azafenidin, pentoxazone, profluazol, flufenpyr-ethyl, pyraclonil, pyriftalid, bispyribac-sodium, pyrithiobac-sodium, pyriminobac-sodium, clodinafop, fenoxaprop, cyhalofop, quizalofop, clethodim and sethoxydim, and b) an amount, effective for herbicide antagonism, of a compound selected from the compounds benoxacor, fenclorim, dichlormid and mefenpyr-diethyl, excluding the mixtures of pyribenzoxim and clodinafop and fenclorim, pyribenzoxim and clodinafop and dichlormid, pyribenzoxim and clodinafop and mefenpyr-diethyl, pyribenzoxim and fenoxaprop and fenclorim, pyribenzoxim and fenoxaprop and dichlormid, pyribenzoxim and fenoxaprop and mefenpyr-diethyl, pyribenzoxim and cyhalofop and fenclorim, pyribenzoxim and cyhalofop and dichlormid, pyribenzoxim and cyhalofop and mefenpyr-diethyl, pyribenzoxim and quizalofop and fenclorim, pyribenzoxim and quizalofop and dichlormid, pyribenzoxim and quizalofop and mefenpyr-diethyl, pyribenzoxim and clethodim and fenclorim, pyribenzoxim and clethodim and dichlormid, pyribenzoxim and clethodim and mefenpyr-diethyl, pyribenzoxim and sethoxydim and fenclorim, pyribenzoxim and sethoxydim and dichlormid, and pyribenzoxim and sethoxydim and mefenpyr-diethyl.

The invention relates also to a method for the selective control of weeds in crops of useful plants, which comprises treating the useful plants, seeds or cuttings thereof, or the area of cultivation thereof, with a herbicidally effective amount of pyribenzoxim, optionally one or more herbicides selected from the compounds S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester, isoxachlortole, chlomethoxyfen, fomesafen, halosafen, lactofen, oxyfluorfen, fluazolate, benzfendizone, cinidon-ethyl, flumiclorac-pentyl, flumioxazin, azafenidin, pentoxazone, profluazol, flufenpyr-ethyl, pyraclonil, pyriftalid, bispyribac-sodium, pyrithiobac-sodium, pyriminobac-sodium, clodinafop, fenoxaprop, cyhalofop, quizalofop, clethodim and sethoxydim, and an amount, effective for herbicide antagonism, of a safener selected from the compounds benoxacor, fenclorim, dichlormid and mefenpyr-diethyl, excluding the mixtures of pyribenzoxim and clodinafop and fenclorim, pyribenzoxim and clodinafop and dichlormid, pyribenzoxim and clodinafop and mefenpyr-diethyl, pyribenzoxim and fenoxaprop and fenclorim, pyribenzoxim and fenoxaprop and dichlormid, pyribenzoxim and fenoxaprop and mefenpyr-diethyl, pyribenzoxim and cyhalofop and fenclorim, pyribenzoxim and cyhalofop and dichlormid, pyribenzoxim and cyhalofop and mefenpyr-diethyl, pyribenzoxim and quizalofop and fenclorim, pyribenzoxim and quizalofop and dichlormid, pyribenzoxim and quizalofop and mefenpyr-diethyl, pyribenzoxim and clethodim and fenclorim, pyribenzoxim and clethodim and dichlormid, pyribenzoxim and clethodim and mefenpyr-diethyl, pyribenzoxim and sethoxydim and fenclorim, pyribenzoxim and sethoxydim and dichlormid, and pyribenzoxim and sethoxydim and mefenpyr-diethyl.

As crop plants that can be protected by the safeners benoxacor, fenclorim, dichlormid and mefenpyr-diethyl against the damaging effect of the above-mentioned herbicides there come into consideration especially cereals, cotton, soybeans, sugar beet, sugar cane, plantation crops, rape, maize and rice, very especially rice. Crops are to be understood as including those that have been made tolerant to herbicides or classes of herbicides by means of conventional breeding or genetic engineering methods. Examples of such crops are glyphosate- or glufosinate-resistant maize varieties commercially available under the trade names RoundupReady® and LibertyLink®.

Crops are to be understood as also including those that have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt 176 maize hybrids of NK® (Syngenta Seeds). The Bt toxin is a protein that is formed naturally by Bacillus thurngiensis soil bacteria. Examples of toxins, or transgenic plants able to synthesise such toxins, are described in EP-A-0 451 878, EP-A-0 374 753, WO 93/07278, WO 95/34656 and EP-A-0 427 529.

The weeds to be controlled may be either monocotyledonous or dicotyledonous weeds such as, for example, Stellaria, Agrostis, Digitaria, Avena, Apera, Brachiaria, Phalaris, Setaria, Sinapis, Lolium, Solanum, Echinochloa, Scirpus, Monochoria, Sagittaria, Panicum, Bromus, Alopecurus, Sorghum halepense, Sorghum bicolor, Rottboellia, Cyperus, Abutilon, Sida, Xanthium, Amaranthus, Chenopodium, Ipomoea, Chrysanthemum, Galium, Viola and Veronica.

Compositions that have been found to be very especially effective are the combinations pyribenzoxim and S-metolachlor and fenclorim, pyribenzoxim and S-metolachlor and benoxacor, pyribenzoxim and S-metolachlor and dichlormid, pyribenzoxim and S-metolachlor and mefenpyr-diethyl, pyribenzoxim and alachlor and fenclorim, pyribenzoxim and alachlor and benoxacor, pyribenzoxim and alachlor and dichlormid, pyribenzoxim and alachlor and mefenpyr-diethyl, pyribenzoxim and metamifop and fenclorim, pyribenzoxim and metamifop and benoxacor, pyribenzoxim and metamifop and dichlormid, pyribenzoxim and metamifop and mefenpyr-diethyl, pyribenzoxim and 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester and fenclorim, pyribenzoxim and 2,2-dimethyl-propionic acid 8-(2,6-diethyl-4-methyl-phenyl)-9-oxo-1,2,4,5-tetrahydro-9H-pyrazolo[1,2-d]-[1,4,5]oxadiazepin-7-yl ester and benoxacor, pyribenzoxim and 2,2-dimethyl-propionic acid 8-(2,6-diethyl-4-methyl-phenyl)-9-oxo-1,2,4,5-tetrahydro-9H-pyrazolo[1,2-d][1,4,5]oxa-diazepin-7-yl ester and dichlormid, pyribenzoxim and 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester and mefenpyr-diethyl, pyribenzoxim and isoxachlortole and fenclorim, pyribenzoxim and isoxachlortole and benoxacor, pyribenzoxim and isoxachlortole and dichlormid, pyribenzoxim and isoxachlortole and mefenpyr-diethyl, pyribenzoxim and chlomethoxyfen and fenclorim, pyribenzoxim and chlomethoxyfen and benoxacor, pyribenzoxim and chlomethoxyfen and dichlormid, pyribenzoxim and chlomethoxyfen and mefenpyr-diethyl, pyribenzoxim and fomesafen and fenclorim, pyribenzoxim and fomesafen and benoxacor, pyribenzoxim and fomesafen and dichlormid, pyribenzoxim and fomesafen and mefenpyr-diethyl, pyribenzoxim and halosafen and fenclorim, pyribenzoxim and halosafen and benoxacor, pyribenzoxim and halosafen and dichlormid, pyribenzoxim and halosafen and mefenpyr-diethyl, pyribenzoxim and lactofen and fenclorim, pyribenzoxim and lactofen and benoxacor, pyribenzoxim and lactofen and dichlormid, pyribenzoxim and lactofen and mefenpyr-diethyl, pyribenzoxim and oxyfluorfen and fenclorim, pyribenzoxim and oxyfluorfen and benoxacor, pyribenzoxim and oxyfluorfen and dichlormid, pyribenzoxim and oxyfluorfen and mefenpyr-diethyl, pyribenzoxim and fluazolate and fenclorim, pyribenzoxim and fluazolate and benoxacor, pyribenzoxim and fluazolate and dichlormid, pyribenzoxim and fluazolate and mefenpyr-diethyl, pyribenzoxim and benzfendizone and fenclorim, pyribenzoxim and benzfendizone and benoxacor, pyribenzoxim and benzfendizone and dichlormid, pyribenzoxim and benzfendizone and mefenpyr-diethyl, pyribenzoxim and cinidon-ethyl and fenclorim, pyribenzoxim and cinidon-ethyl and benoxacor, pyribenzoxim and cinidon-ethyl and dichlormid, pyribenzoxim and cinidon-ethyl and mefenpyr-diethyl, pyribenzoxim and flumiclorac-pentyl and fenclorim, pyribenzoxim and flumiclorac-pentyl and benoxacor, pyribenzoxim and flumiclorac-pentyl and dichlormid, pyribenzoxim and flumiclorac-pentyl and mefenpyr-diethyl, pyribenzoxim and flumioxazin and fenclorim, pyribenzoxim and flumioxazin and benoxacor, pyribenzoxim and flumioxazin and dichlormid, pyribenzoxim and flumioxazin and mefenpyr-diethyl, pyribenzoxim and azafenidin and fenclorim, pyribenzoxim and azafenidin and benoxacor, pyribenzoxim and azafenidin and dichlormid, pyribenzoxim and azafenidin and mefenpyr-diethyl, pyribenzoxim and pentoxazone and fenclorim, pyribenzoxim and pentoxazone and benoxacor, pyribenzoxim and pentoxazone and dichlormid, pyribenzoxim and pentoxazone and mefenpyr-diethyl, pyribenzoxim and profluazol and fenclorim, pyribenzoxim and profluazol and benoxacor, pyribenzoxim and profluazol and dichlormid, pyribenzoxim and profluazol and mefenpyr-diethyl, pyribenzoxim and flufenpyr-ethyl and fenclorim, pyribenzoxim and flufenpyr-ethyl and benoxacor, pyribenzoxim and flufenpyr-ethyl and dichlormid, pyribenzoxim and flufenpyr-ethyl and mefenpyr-diethyl, pyribenzoxim and pyraclonil and fenclorim, pyribenzoxim and pyraclonil and benoxacor, pyribenzoxim and pyraclonil and dichlormid, pyribenzoxim and pyracionil and mefenpyr-diethyl, pyribenzoxim and pyriftalid and fenclorim, pyribenzoxim and pyriftalid and benoxacor, pyribenzoxim and pyriftalid and dichlormid, pyribenzoxim and pyriftalid and mefenpyr-diethyl, pyribenzoxim and bispyribac-sodium and fenclorim, pyribenzoxim and bispyribac-sodium and benoxacor, pyribenzoxim and bispyribac-sodium and dichlormid, pyribenzoxim and bispyribac-sodium and mefenpyr-diethyl, pyribenzoxim and pyrithiobac-sodium and fenclorim, pyribenzoxim and bispyribac-sodium and benoxacor, pyribenzoxim and pyrithiobac-sodium and dichlormid, pyribenzoxim and pyrithiobac-sodium and mefenpyr-diethyl, pyribenzoxim and pyriminobac-sodium and fenclorim, pyribenzoxim and pyriminobac-sodium and benoxacor, pyribenzoxim and pyriminobac-sodium and dichlormid, pyribenzoxim and pyriminobac-sodium and mefenpyr-diethyl, pyribenzoxim and clodinafop and benoxacor, pyribenzoxim and fenoxaprop and benoxacor, pyribenzoxim and cyhalofop and benoxacor, pyribenzoxim and quizalofop and benoxacor, pyribenzoxim and clethodim and benoxacor, pyribenzoxim and sethoxydim and benoxacor, pyribenzoxim and fenclorim, pyribenzoxim and benoxacor, pyribenzoxim and dichlormid, and pyribenzoxim and mefenpyr-diethyl.

Areas of cultivation are areas of land on which the crop plants are already growing or in which the seed material of those crop plants has been sown, and also land on which it is intended to grow those crop plants.

A safener selected from the compounds benoxacor, fenclorim, dichlormid and mefenpyr-diethyl may, depending on the intended use, be used to pre-treat the seed material of the crop plant (dressing the seed or the cuttings) or may be incorporated into the soil before or after sowing. It may, however, also be applied, alone or together with the herbicide, after the emergence of the plants. The treatment of the plants or seed material with the safener can therefore, in principle, be effected independently of the time at which the herbicide is applied. The treatment of the plants can, however, also be carried out by applying the herbicide and safener simultaneously (for example in the form of a tank mixture). The rate of application of the safener in relation to the herbicide depends largely on the method of application. In the case of field treatment, which is carried out either by using a tank mixture comprising a combination of safener and herbicide or by separate application of safener and herbicide, the ratio of herbicides to safener is generally from 100:1 to 1:10, preferably from 20:1 to 1:1. In the case of field treatment, from 0.001 to 1.0 kg of safener per hectare, preferably from 0.001 to 0.25 kg of safener per hectare, is generally applied.

The rates of application of herbicides are generally from 0.001 to 5 kg/ha, but preferably from 0.005 to 0.5 kg/ha.

The compositions according to the invention are suitable for all methods of application conventionally used in agriculture, e.g. pre-emergence application, post-emergence application and seed dressing.

In the case of seed dressing, generally from 0.001 to 10 g of safener per kg of seed, preferably from 0.05 to 2 g of safener per kg of seed, are applied. If the safener is applied in liquid form, by seed soaking, shortly before sowing, it is advantageous to use safener solutions containing the active ingredient in a concentration of from 1 to 10 000 ppm, especially from 100 to 1000 ppm.

For application, the safeners selected from the compounds benoxacor, fenclorim, dichlormid and mefenpyr-diethyl or combinations of those safeners with pyribenzoxim and, optionally, one or more herbicides selected from the compounds S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester, isoxachlortole, chlomethoxyfen, fomesafen, halosafen, lactofen, oxyfluorfen, fluazolate, benzfendizone, cinidon-ethyl, flumiclorac-pentyl, flumioxazin, azafenidin, pentoxazone, profluazol, flufenpyr-ethyl, pyraclonil, pyriftalid, bispyribac-sodium, pyrithiobac-sodium, pyriminobac-sodium, clodinafop, fenoxaprop, cyhalofop, quizalofop, clethodim and sethoxydim are advantageously processed together with the adjuvants customary in formulation technology into formulations, for example into emulsifible concentrates, coatable pastes, directly sprayable or dilutable solutions, dilute emulsions, wettable powders, soluble powders, dusts, granules or microcapsules.

Such formulations are described, for example, on pages 9 to 13 of WO 97/34485. The formulations are prepared in known manner, for example by intimately mixing and/or grinding the active ingredients with liquid or solid formulation adjuvants such as, for example, solvents or solid carriers. It is also possible additionally to use surface-active compounds (surfactants) in the preparation of the formulations. Solvents and solid carriers suitable for that purpose are mentioned, for example, on page 6 of WO 97/34485.

Depending on the nature of the active ingredient to be formulated, suitable surface-active compounds are non-ionic, cationic and/or anionic surfactants and surfactant mixtures having good emulsifying, dispersing and wetting properties. Examples of suitable anionic, non-ionic and cationic surfactants are listed, for example, in WO 97/34485, pages 7 and 8. Also suitable for the preparation of the herbicidal compositions according to the invention are the surfactants conventionally used in formulation technology, which are described, inter alia, in “McCutcheon's Detergents and Emulsifiers Annual” MC Publishing Corp., Ridgewood N.J., 1981, Stache, H., “Tensid-Taschenbuch”, Carl HanserVerlag, MunichNienna, 1981 and M. and J. Ash, “Encyclopedia of Surfactants”, Vol I-III, Chemical Publishing Co., New York, 1980-81.

The herbicidal formulations usually contain from 0.1 to 99% by weight, especially from 0.1 to 95% by weight, of active ingredient mixture comprising pyribenzoxim and a compound selected from the compounds S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d][1,4,5]-oxadiazepin-7-yl ester, isoxachlortole, chlomethoxyfen, fomesafen, halosafen, lactofen, oxyfluorfen, fluazolate, benzfendizone, cinidon-ethyl, flumiclorac-pentyl, flumioxazin, azafenidin, pentoxazone, profluazol, flufenpyr-ethyl, pyraclonil, pyriftalid, bispyribac-sodium, pyrithiobac-sodium, pyriminobac-sodium, clodinafop, fenoxaprop, cyhalofop, quizalofop, clethodim and sethoxydim, and the compounds benoxacor, fenclorim, dichlormid and mefenpyr-diethyl, to 99.9% by weight of a solid or liquid formulation adjuvant, and from 0 to 25% by weight, especially from 0.1 to 25% by weight, of a surfactant. Whereas concentrates are usually preferred as commercial products, the end user will normally employ dilute formulations.

The compositions may also comprise further ingredients, such as stabilisers, e.g. vegetable oils or epoxidised vegetable oils (epoxidised coconut oil, rapeseed oil or soybean oil), antifoams, e.g. silicone oil, preservatives, viscosity regulators, binders, tackifiers, and also fertilisers or other active ingredients. For the use of safeners selected from the compounds benoxacor, fenclorim, dichlormid and mefenpyr-diethyl or of compositions comprising them for the protection of crop plants against harmful effects of herbicides selected from the compounds S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester, isoxachlortole, chlomethoxyfen, fomesafen, halosafen, lactofen, oxyfluorfen, fluazolate, benzfendizone, cinidon-ethyl, flumiclorac-pentyl, flumioxazin, azafenidin, pentoxazone, profluazol, flufenpyr-ethyl, pyraclonil, pyriftalid, bispyribac-sodium, pyrithiobac-sodium, pyriminobac-sodium, clodinafop, fenoxaprop, cyhalofop, quizalofop, clethodim and sethoxydim, various methods and techniques are suitable; the following are examples:

i) Seed Dressing

a) Dressing the seeds with a wettable powder formulation of active ingredient selected from the compounds benoxacor, fenclorim, dichlormid and mefenpyr-diethyl by shaking in a vessel until the formulation is uniformly distributed over the seed surface (dry dressing). Approximately from 1 to 500 g of active ingredient selected from the compounds benoxacor, fenclorim, dichlormid and mefenpyr-diethyl (from 4 g to 2 kg of wettable powder) are used per 100 kg of seed material.
b) Dressing the seeds with an emulsifiable concentrate of active ingredient selected from the compounds benoxacor, fenclorim, dichlormid and mefenpyr-diethyl according to method a) (wet dressing).
c) Dressing by immersing the seed material in a liquid formulation comprising from 100 to 1000 ppm of active ingredient selected from the compounds benoxacor, fenclorim, dichlormid and mefenpyr-diethyl for from 1 to 72 hours and, if desired, subsequently drying the seeds (immersion dressing).

Dressing the seed material or treating the germinated seedlings are naturally the preferred methods of application because the treatment with active ingredient is directed wholly at the target crop. Generally from 1 to 1000 g of antidote, preferably from 5 to 250 g of antidote, are used per 100 kg of seed material, although, depending on the method employed, which also allows the addition of other active ingredients or micronutrients, amounts above or below the specified concentration limits may be employed (repeat dressing).

ii) Application in the Form of a Tank Mixture

A liquid formulation of a mixture of antidote and herbicide (ratio of the one to the other from 10:1 to 1:100) is used, the rate of application of herbicide being from 0.005 to 5.0 kg per hectare. Such tank mixtures are applied before or after sowing.

iii) Application to the Seed Furrow

The active ingredients benoxacor or fenclorim are introduced into the open, sown seed furrow in the form of an emulsifiable concentrate, a wettable powder or granules. After the seed furrow has been covered, the herbicide is applied pre-emergence in the normal manner.

iv) Controlled Release of the Active Ingredient

The active ingredients benoxacor, fenclorim, dichlormid and mefenpyr-diethyl are applied in solution to granulated mineral carriers or polymerised granules (urea-formaldehyde) and dried. If desired, a coating may be applied (coated granules) which enables the active ingredient to be released in metered amounts over a predetermined period of time. Preferred formulations have especially the following compositions (%=percent by weight)

Emulsifiable Concentrates:

| | |
|---|---|
| active ingredient mixture: | from 1 to 90%, preferably from 5 to 20% |
| surface-active agent: | from 1 to 30%, preferably from 10 to 20% |
| liquid carrier: | from 5 to 94%, preferably from 70 to 85% |

Dusts:

| | |
|---|---|
| active ingredient mixture: | from 0.1 to 10%, preferably from 0.1 to 5% |
| solid carrier: | from 99.9 to 90%, preferably from 99.9 to 99% |

Suspension Concentrates:

| | |
|---|---|
| active ingredient mixture: | from 5 to 75%, preferably from 10 to 50% |
| water: | from 94 to 24%, preferably from 88 to 30% |
| surface-active agent: | from 1 to 40%, preferably from 2 to 30% |

Wettable Powders:

| | |
|---|---|
| active ingredient mixture: | from 0.5 to 90%, preferably from 1 to 80% |
| surface-active agent: | from 0.5 to 20%, preferably from 1 to 15% |
| solid carrier: | from 5 to 95%, preferably from 15 to 90% |

Granules:

| | |
|---|---|
| active ingredient mixture: | from 0.1 to 30%, preferably from 0.1 to 15% |
| solid carrier: | from 99.5 to 70%, preferably from 97 to 85% |

The Examples that follow illustrate the invention further. They do not limit the invention.

Formulation Examples for mixtures comprising the herbicide pyribenzoxim, optionally compounds selected from S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d][1,4,5]-oxadiazepin-7-yl ester, isoxachlortole, chlomethoxyfen, fomesafen, halosafen, lactofen, oxyfluorfen, fluazolate, benzfendizone, cinidon-ethyl, flumiclorac-pentyl, flumioxazin, azafenidin, pentoxazone, profluazol, flufenpyr-ethyl, pyraclonil, pyriftalid, bispyribac-sodium, pyrithiobac-sodium, pyriminobac-sodium, clodinafop, fenoxaprop, cyhalofop, quizalofop, clethodim and sethoxydim, and safeners selected from the compounds benoxacor, fenclorim, dichlormid and mefenpyr-diethyl (%=percent by weight):

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| aromatic C₉-C₁₂hydrocarbon mixture | 85% | 78% | 55% | 16% |

Emulsions of any desired concentration can be prepared from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol (mol. wt. 400) | 20% | 10% | — | — |
| N-methyl-2-pyrrolidone | — | — | 30% | 10% |
| aromatic C₉-C₁₂hydrocarbon mixture | 75% | 60% | — | — |

The solutions are suitable for application in the form of micro-drops.

| F3. Wettable Powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalenesulfonate | — | 6% | 5% | 6% |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier material | 99.0% | 93% | 83% |
| (diameter 0.1 - 1 mm) | | | |
| for example CaCO₃ or SiO₂ | | | |

The active ingredient is dissolved in methylene chloride, the solution is sprayed onto the carrier, and the solvent is subsequently evaporated off in vacuo.

| F5. Coated granules | a) | b) | c) |
|---|---|---|---|
| active ingredient mixture | 0.1% | 5% | 15% |
| polyethylene glycol (mol. wt. 200) | 1.0% | 2% | 3% |
| highly dispersed silicic acid | 0.9% | 1% | 2% |
| inorganic carrier material | 98.0% 92% | 80% | |
| (diameter 0.1 - 1 mm) | | | |
| for example CaCO₃ or SiO₂ | | | |

The finely ground active ingredient is uniformly applied, in a mixer, to the carrier material moistened with polyethylene glycol, yielding non-dusty coated granules.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed with the adjuvants, and the mixture is ground, moistened with water, extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical to formulate the active ingredients pyribenzoxim and S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester, isoxachlortole, chlomethoxyfen, fomesafen, halosafen, lactofen, oxyfluorfen, fluazolate, benzfendizone, cinidon-ethyl, flumiclorac-pentyl, flumioxazin, azafenidin, pentoxazone, profluazol, flufenpyr-ethyl, pyraclonil, pyriftalid, bispyribac-sodium, pyrithiobac-sodium, pyriminobac-sodium, clodinafop, fenoxaprop, cyhalofop, quizalofop, clethodim and sethoxydim, and benoxacor, fenclorim, dichlormid and mefenpyr-diethyl separately and then, shortly before application, to bring them together in the applicator in the desired mixing ratio in the form of a “tank mixture” in water.

The ability of the safeners selected from the compounds benoxacor, fenclorim, dichlormid and mefenpyr-diethyl to protect crop plants against the phytotoxic action of pyribenzoxim alone and/or of mixtures of pyribenzoxim and one or more herbicides selected from the compounds S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester, isoxachlortole, chlomethoxyfen, fomesafen, halosafen, lactofen, oxyfluorfen, fluazolate, benzfendizone, cinidonethyl, flumiclorac-pentyl, flumioxazin, azafenidin, pentoxazone, profluazol, flufenpyr-ethyl, pyraclonil, pyriftalid, bispyribac-sodium, pyrithiobac-sodium, pyriminobac-sodium, clodinafop, fenoxaprop, cyhalofop, quizalofop, clethodim and sethoxydim is illustrated in the following Examples.

### BIOLOGICAL EXAMPLE

### Example B3

### Safening Action

The test plants are grown to the 4-leaf stage in plastics pots under greenhouse conditions. At that stage pyribenzoxim, both alone and in combination with safener, and also mixtures of pyribenzoxim and one or more herbicides, or mixtures of pyribenzoxim and one or more herbicides together with the substances being tested as safeners, are applied to the test plants. The application is carried out using an aqueous suspension of the test substances prepared from a 25% wettable powder (Example F3, b)) or from a suspension concentrate as in Example F8, using 500 litres of water per hectare. 3 weeks after application, the phytotoxic action of the herbicides on the crop plants such as, for example, maize and cereals is evaluated using a percentage scale. 100% means that the test plant is completely dead; 0% means that there is no phytotoxic action. The mixtures according to the invention show good activity in this test.

1. A herbicidal synergistic composition which, in addition to comprising customary inert formulation adjuvants, comprises as active ingredient a mixture of
a) pyribenzoxim and
b) a synergistically effective amount of at least one compound selected from the compounds of the group benzobicyclon, benzofenap, pyraflufen-ethyl, beflubutamid, cafenstrole, dimethametryn, clomeprop, trifloxysulfuron, N-[(4,6-dimethoxypyrimidin-2-yl)aminocarbonyl]-2-(2-fluoro-1-methoxy-acetoxy-n-propyl)pyridine-3-sulfonamide, S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester, isoxachlortole, chlomethoxyfen, fomesafen, halosafen, lactofen, oxyfluorfen, fluazolate, benzfendizone, cinidon-ethyl, flumiclorac-pentyl, flumioxazin, azafenidin, pentoxazone, profluazol, flufenpyr-ethyl, pyraclonil, pyriftalid, bispyribac-sodium, pyrithiobac-sodium and pyriminobac-sodium.

2. A method of controlling undesired plant growth in crops of useful plants, which comprises allowing a herbicidally effective amount of a composition according to claim 1 to act on the crop plant or the locus thereof.

3. A method according to claim 2, wherein the crop plant is rice.

4. A herbicidal synergistic composition comprising as active ingredient a mixture of
a) pyribenzoxim and
b) a synergistically effective amount of at least one compound selected from the compounds of the group S-metolachlor, alachlor, metamifop, 2,2-dimethyl-propionic acid 8-(2,6-diethyl-4-methyl-phenyl)-9-oxo-1,2,4,5-tetrahydro-9H-pyrazolo[1,2-d][1,4,5]oxadiazepin-7-yl ester, isoxachlortole, chlomethoxyfen, fomesafen, halosafen, lactofen, oxyfluorfen, fluazolate, benzfendizone, cinidon-ethyl, flumiclorac-pentyl, flumioxazin, azafenidin, pentoxazone, profluazol, flufenpyr-ethyl, pyraclonil, pyriftalid, bispyribac-sodium, pyrithiobac-sodium, pyriminobac-sodium, clodinafop, fenoxaprop, cyhalofop, quizalofop, clethodim and sethoxydim, and
c) an amount, effective for herbicide antagonism, of a compound selected from the compounds benoxacor, fenclorim, dichlormid and mefenpyr-diethyl, excluding the mixtures of pyribenzoxim and clodinafop and fenclorim, pyribenzoxim and clodinafop and dichlormid, pyribenzoxim and clodinafop and mefenpyr-diethyl, pyribenzoxim and fenoxaprop and fenclorim, pyribenzoxim and fenoxaprop and dichlormid, pyribenzoxim and fenoxaprop and mefenpyr-diethyl, pyribenzoxim and cyhalofop and fenclorim, pyribenzoxim and cyhalofop and dichlormid, pyribenzoxim and cyhalofop and mefenpyr-diethyl, pyribenzoxim and quizalofop and fenclorim, pyribenzoxim and quizalofop and dichlormid, pyribenzoxim and quizalofop and mefenpyr-diethyl, pyribenzoxim and clethodim and fenclorim, pyribenzoxim and clethodim and dichlormid, pyribenzoxim and clethodim and mefenpyr-diethyl, pyribenzoxim and sethoxydim and fenclorim, pyribenzoxim and sethoxydim and dichlormid, and pyribenzoxim and sethoxydim and mefenpyr-diethyl.

5. A herbicidal composition which, in addition to comprising customary inert formulation adjuvants, comprises as active ingredient a mixture of
a) pyribenzoxim and
b) an amount, effective for herbicide antagonism, of a compound selected from the compounds benoxacor, fenclorim, dichlormid and mefenpyr-diethyl.

6. A method of controlling undesired plant growth in crops of useful plants, which comprises allowing a herbicidally effective amount of a composition according to claim 4 to act on the crop plant or the locus thereof.

7. A method according to claim 6, wherein the crop plant is rice.

8. A method of controlling undesired plant growth in crops of useful plants, which comprises allowing a herbicidally effective amount of a composition according to claim 5 to act on the crop plant or the locus thereof.

9. A method according to claim 8, wherein the crop plant is rice.
